(19) United States
(12) Patent Application Publication
(10) Pub. No.: US 2005/0140934 A1
(43) Pub. Date: Jun. 30, 2005

(54) Projection device

(75) Inventors: Eun Seong Seo, Seoul (KR); Young Woon Kim, Suwon-si (KR); Sang Sik Jeong, Gunpo-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/024,489

(22) Filed: Dec. 30, 2004

(30) Foreign Application Priority Data
Dec. 31, 2003 (KR) 10-2003-0102318

(51) Int. Cl. G03B 21/00

(52) U.S. Cl. 353/46

(57) ABSTRACT

The present invention relates to a projection device, and more particularly, to a projection device in which an image of a resolution higher than a resolution of a display panel included therein can be displayed. According to the present invention, the projection device is a projection device that projects an image signal onto a screen, the projecting device including image forming means that forms an image by using an inputted image signal, and image shift means that transmits the image intact or shifts the image, and projects the intact or shifted image onto the screen. Therefore, the projection device according to the present invention can provide an image of a high resolution by using a digital display panel that supports a low resolution.

This Nonprovisional application claims priority under 35 U.S.C. § 119(a) on Patent Application No. 10-2003-0102318 filed in Korea on Dec. 31, 2003, the entire contents of which are hereby incorporated by reference.

### BACKGROUND OF THE INVENTION

1. Field of the Invention

The present invention relates to a projection device, and more particularly, to a projection device in which an image of a resolution higher than a resolution of a display panel included therein can be displayed.

2. Description of the Background Art

Generally, a projection device is a device, which is composed of a light source and an optical system and is adapted to magnify an image and to project the magnified image onto a screen. In the past, a projection device in which a cathode ray tube (CRT) is mounted was usually employed. Recently, various kinds of projectors using a liquid crystal display (LCD) panel, a digital mirror device (DMD) panel or a liquid crystal on silicon (LCoS) panel and the like have been commercialized.

In the projection device having the LCD panel mounted in, in the case of a three-panel type, three liquid crystal panels have the three colors of spectrum red, blue and green pass pixels of the liquid crystal and have a lens collect light that have passed the pixels to produce an image.

In the projection device having the DMD panel mounted in, thousands of fine mirrors corresponding to pixels are integrated into a chip called DMD. The mirrors having a slant form an image depending on the degree of reflection of light.

Furthermore, the projection device having the LCoS panel mounted in has a silicon wafer into which a LCD is integrated. It is advantageous in that the number of pixels is less limited than that of the LCD or DMD mode.

Of the various projection devices, the projection devices of the LCD mode and the DMD mode cannot provide an image of a maximum resolution 720p in terms of a mounted panel. The projection device having the LCoS panel mounted in is advantageous in that it can provide a resolution higher than that of the projection device of the LCD mode and the DMD mode, but is disadvantageous in that the price of the projection device is high.

### SUMMARY OF THE INVENTION

Accordingly, an object of the present invention is to solve at least the problems and disadvantages of the background art.

An object of the present invention is to provide a high resolution projection device in which an image of a high resolution can be provided by using a digital display panel that supports a low resolution.

A projection device according to Claim 1 of the present invention is a projection device that projects an image signal onto a screen, the projection device includes image forming means that forms an image by using an inputted image signal, and image shift means that transmits the image intact or shifts the image, and projects the intact or shifted image onto the screen.

A projection method according to Claim 6 of the present invention is a projection method in which an image signal is projected onto a screen, the projecting method comprising the steps of: an image forming step of forming an image by using an inputted image signal, and an image shift step of transmitting the image intact or shifting the image, thus projecting the image onto the screen.

A projection device according to Claim 11 of the present invention is a projection device that projects an image signal onto a screen, the projection device including partial image forming means that divides an image signal constituting one screen so that the image signal is suitable for a resolution of a display panel, thus forming several partial images, and image shift means, which transmits or shifts the several partial images and thus projects the image onto the screen.

A projection method according to Claim 17 of the present invention is a projection method that projects an image signal onto a screen, the projection method includes a partial image forming step of dividing an image signal constituting one screen so that the image signal is suitable for a resolution of a display panel, thus forming several partial images, and an image shift step of transmitting or shifting the several partial images, thus projecting the image onto the screen.

A projection device according to Claim 22 of the present invention is a projection device that projects an image signal onto a screen, the projection device including a display driving unit that transforms an inputted image signal, which constitutes one screen, into a partial image signal so that the image signal is suitable for a resolution of a display panel, an image forming unit including the display panel, the image forming unit converting the partial image signal into an image optical signal, an optical path changing unit that forms a partial image by using the image optical signal, an image shift unit, which transmits the partial image intact in a first state and shifts the partial image in a second state, under the control of the display driving unit, and a projection lens unit that projects the partial image outputted from the image shift unit onto the screen.

A projection device according to Claim 48 of the present invention is a projection device including a display panel that supports the number of scanning lines, which is 1/n times greater than the number of scanning lines of an image signal constituting one screen, the projecting device including a display driving unit that converts the image signal constituting the one screen into n number of partial image signals so that the image signal is suitable for the display panel, an image forming unit including the display panel, wherein the image forming unit converts the n number of the partial image signals into n number of image optical signals, an optical path changing unit that forms n number of partial images by using the n number of the image optical signals, an image shift unit, which transmits a first partial image among the n number of the partial image intact in a first state, and shifts second to n^{th} partial images among the n number of the partial image in a second state, under the control of the display driving unit, and a projection lens unit that projects the first to n^{th} partial images outputted from the image shift unit onto the screen.

A projection device according to Claim 57 of the present invention is a projection device including a display panel that supports the number of scanning lines, which is 1/n times greater than the number of scanning lines of an image signal constituting one screen, the projection device including a display driving unit that converts the image signal constituting the one screen into n number of partial image signals so that the image signal is suitable for the display panel, an image forming unit including the display panel, wherein the image forming unit converts the n number of the partial image signals into n number of image optical signals, an optical path changing unit that forms n number of partial images by using the n number of the image optical signals, an image shift unit, which transmits a first partial image among the n number of the partial image intact in a first state, and shifts second to n^{th} partial images among the n number of the partial image in a second state, under the control of the display driving unit, and a projection lens unit that projects the first to n^{th} partial images outputted from the image shift unit onto the screen, wherein the display panel is three transmission-type LCDs, the optical path changing unit includes a X-prism, and the image shift unit includes a polarization conversion unit that converts light into an S wave or a P wave, and a birefringence unit that causes birefringence in the S wave or the P wave.

A projection device according to Claim 58 of the present invention is a projection device including a display panel that supports the number of scanning lines, which is 1/n times greater than the number of scanning lines of an image signal constituting one screen, the projection device including a display driving unit that converts the image signal constituting the one screen into n number of partial image signals so that the image signal is suitable for the display panel, an image forming unit including the display panel, wherein the image forming unit converts the n number of the partial image signals into n number of image optical signals, an optical path changing unit that forms n number of partial images by using the n number of the image optical signals, an image shift unit, which transmits a first partial image among the n number of the partial image intact in a first state, and shifts second to n^{th} partial images among the n number of the partial image in a second state, under the control of the display driving unit, and a projection lens unit that projects the first to n^{th} partial images outputted from the image shift unit onto the screen, wherein the display panel is a single DMD panel, the optical path changing unit includes a TIR prism, and the image shift unit includes a transmitting body, and a piezoelectric ceramic element connected to the transmitting body.

According to a projection device in accordance with the present invention, an image of a high resolution can be provided by using a digital display panel that supports a low resolution.

### BRIEF DESCRIPTION OF THE DRAWINGS

The invention will be described in detail with reference to the following drawings in which like numerals refer to like elements.

FIG. 1 is a block diagram of a projection device, which can increase a resolution according to the present invention;

FIG. 2 is a block diagram of a display driving unit included in the projection device according to the present invention;

FIG. 3 is a view for explaining the operation of the display driving unit according to the present invention;

FIG. 4 shows an operating waveform of the display driving unit according to the present invention;

FIG. 5 is a block diagram of a projection device in which a resolution can be increased according to a first embodiment of the present invention; and

FIGS. 6 and 7 are block diagrams of a projection device in which a resolution can be increased according to a second embodiment of the present invention.

### DETAILED DESCRIPTION OF PREFERRED EMBODIMENTS

Preferred embodiments of the present invention will be described in a more detailed manner with reference to the drawings.

A projection device according to Claim 1 of the present invention is a projection device that projects an image signal onto a screen, the projection device includes image forming means that forms an image by using an inputted image signal, and image shift means that transmits the image intact or shifts the image, and projects the intact or shifted image onto the screen.

In the invention according to Claim 1, the image forming means forms an image by using an inputted image signal. The image shift means transmits the formed image intact or shifts the image, thus projecting the image. Accordingly, even a projection device including a display panel of a low resolution can form a partial image so as to be suitable for the display panel of the low resolution, and then properly project the partial image onto the screen. This makes a person view the screen with a resolution of an image signal constituting one screen.

According to Claim 2, in the projection device according to Claim 1, the image shift means includes a polarization conversion unit that converts light into an S wave or a P wave, and a birefringence unit that causes birefringence in the S wave or the P wave.

In the invention according to Claim 2, the image shift means includes the polarization conversion unit and the birefringence unit, and performs a function of shifting the image.

According to Claim 3, in the projection device according to Claim 2, the polarization conversion unit and the birefringence unit are one or more in number, respectively.

In the invention according to Claim 3, the number of each of the polarization conversion unit and the birefringence unit, which constitute the image shift means, can be one or more.

According to Claim 4, in the projection device according to Claim 1, the image shift means includes a transmitting body, and a piezoelectric ceramic element connected to the transmitting body.

The invention according to Claim 4 is the projection device in which the image shift means is composed of the transmitting body and the piezoelectric ceramic element, unlike Claim 2, thereby performing the function of shifting the image.

According to Claim 5, in the projection device according to Claim 4, the transmitting body can be moved, and can transmit or shift the image by way of the movement.

In the invention according to Claim 5, it is possible to shift the image by controlling the movement of the transmitting body by means of the piezoelectric ceramic element.

A projection method according to Claim 6 of the present invention is a projection method in which an image signal is projected onto a screen, the projecting method comprising the steps of: an image forming step of forming an image by using an inputted image signal, and an image shift step of transmitting the image intact or shifting the image, thus projecting the image onto the screen.

In the invention according to Claim 6, an inputted image signal is formed by an image. The image signal is transmitted intact or shifted, thus being projected onto a screen. Accordingly, even a projection device including a display panel of a low resolution can form a partial image so as to be suitable for the display panel of the low resolution, and then properly project the partial image onto the screen. This makes a person view the screen with a resolution of an image signal constituting one screen.

According to Claim 7, in the projection method according to Claim 6, the image shift step is performed by an image shift means including a polarization conversion unit that converts light into an S wave or a P wave, and a birefringence unit that causes birefringence in the S wave or the P wave.

In the invention according to Claim 7, the image shift means is composed of the polarization conversion unit and the birefringence unit, thus performing a function of shifting an image.

According to Claim 8, in the projection method according to Claim 7, the polarization conversion unit and the birefringence unit are one or more in number, respectively.

In the invention according to Claim 8 the number of the polarization conversion unit and the birefringence unit, which constitutes the image shift means, can be one or more.

According to Claim 9, in the projection method according to Claim 6, the image shift step is performed by image shift means including a transmitting body, and a piezoelectric ceramic element connected to the transmitting body.

The invention according to Claim 9 is a projection method in which the image shift means is composed of the transmitting body and the piezoelectric ceramic element, unlike Claim 2, thereby performing the function of shifting the image.

According to Claim 10, in the projection method according to Claim 9, the transmitting body can be moved, and can transmit or shift the image by way of the movement.

In the invention according to Claim 10, the piezoelectric ceramic element can shift the image by controlling the movement of the transmitting body.

A projection device according to Claim 11 of the present invention is a projection device that projects an image signal onto a screen, the projection device including partial image forming means that divides an image signal constituting one screen so that the image signal is suitable for a resolution of a display panel, thus forming several partial images, and image shift means, which transmits or shifts the several partial images and thus projects the image onto the screen.

In the invention according to Claim 11, an image signal constituting one screen is divided according to a resolution of a display panel by using the image forming means, thus forming several partial images. The several partial images are transmitted intact or shifted by using the image shift means, and are then projected onto the screen. Accordingly, even a projection device including a display panel of a low resolution can form a partial image so as to be suitable for the display panel of the low resolution, and then properly project the partial image onto the screen. This makes a person view the screen with a resolution of an image signal constituting one screen.

According to Claim 12, in the projection device according to Claim 11, the image shift means includes a polarization conversion unit that converts light into an S wave or a P wave, and a birefringence unit that causes birefringence in the S wave or the P wave.

In the invention according to Claim 12, the image shift means includes the polarization conversion unit and the birefringence unit, and performs a function of shifting the image.

According to Claim 13, in the projection device according to Claim 12, the polarization conversion unit and the birefringence unit are one or more in number, respectively.

In the invention according to Claim 13, the number of each of the polarization conversion unit and the birefringence unit, which constitute the image shift means, can be one or more.

According to Claim 14, in the projection device according to Claim 11, the image shift means includes a transmitting body, and a piezoelectric ceramic element connected to the transmitting body.

The invention according to Claim 14 is the projection device in which the image shift means is composed of the transmitting body and the piezoelectric ceramic element, unlike Claim 2, thereby performing the function of shifting the image.

According to Claim 15, in the projection device according to Claim 14, the transmitting body can be moved, and can transmit or shift the image by way of the movement.

In the invention according to Claim 15, it is possible to shift the image by controlling the movement of the transmitting body by means of the piezoelectric ceramic element.

According to Claim 16, in the projection device according to any one of Claims 11 to 15, the image shift means can be disposed at a given position between the display panel and the screen.

In the invention according to Claim 16, the image shift means can be disposed at a given position of a predetermined region of the projection device.

A projection method according to Claim 17 of the present invention is a projection method that projects an image signal onto a screen, the projection method includes a partial image forming step of dividing an image signal constituting one screen so that the image signal is suitable for a resolution of a display panel, thus forming several partial images, and an image shift step of transmitting or shifting the several partial images, thus projecting the image onto the screen.

In the invention according to Claim 17, an image signal constituting one screen is divided according to a resolution of a display panel by using the image forming means, thus forming several partial images. The several partial images are transmitted intact or shifted by using the image shift means, and are then projected onto the screen. Accordingly, even a projection device including a display panel of a low resolution can form a partial image so as to be suitable for the display panel of the low resolution, and then properly project the partial image onto the screen. This makes a person view the screen with a resolution of an image signal constituting one screen.

According to Claim 18, in the projection method according to Claim 17, the image shift step is performed by an image shift means including a polarization conversion unit that converts light into an S wave or a P wave, and a birefringence unit that causes birefringence in the S wave or the P wave.

In the invention according to Claim 18, the image shift step is performed by an image shift means including a polarization conversion unit that converts light into an S wave or a P wave, and a birefringence unit that causes birefringence in the S wave or the P wave, so that a function of shifting an image can be performed.

According to Claim 19, in the projection method according to Claim 18, the polarization conversion unit and the birefringence unit are one or more in number, respectively.

In the invention according to Claim 19, the number of the polarization conversion unit and the birefringence unit, which constitutes the image shift means, can be one or more.

According to Claim 20, in the projection method according to Claim 17, the image shift step is performed by image shift means including a transmitting body, and a piezoelectric ceramic element connected to the transmitting body.

The invention according to Claim 20 is a projection method in which the image shift step is performed by image shift means including a transmitting body, and a piezoelectric ceramic element connected to the transmitting body, unlike Claim 18, so that a function of shifting the image can be performed.

According to Claim 21, in the projection method according to Claim 20, the transmitting body can be moved, and can transmit or shift the image by way of the movement.

In the invention according to Claim 21, the piezoelectric ceramic element can shift the image by controlling the movement of the transmitting body.

A projection device according to Claim 22 of the present invention is a projection device that projects an image signal onto a screen, the projection device including a display driving unit that transforms an inputted image signal, which constitutes one screen, into a partial image signal so that the image signal is suitable for a resolution of a display panel, an image forming unit including the display panel, the image forming unit converting the partial image signal into an image optical signal, an optical path changing unit that forms a partial image by using the image optical signal, an image shift unit, which transmits the partial image intact in a first state and shifts the partial image in a second state, under the control of the display driving unit, and a projection lens unit that projects the partial image outputted from the image shift unit onto the screen.

In the invention according to Claim 22, an image signal constituting one screen is divided so as to be suitable for a resolution of a display panel by using the display driving unit, the image forming unit and the optical path changing unit, thus forming several partial images. The image shift unit transmits the several partial images intact or shifts them, and then projects the partial images onto the screen. Accordingly, even a projection device including a display panel of a low resolution can form a partial image so as to be suitable for the display panel of the low resolution, and then properly project the partial image onto the screen. This makes a person view the screen with a resolution of an image signal constituting one screen.

According to Claim 23, in the projection device according to Claim 22, the display driving unit includes a resolution conversion unit for forming the partial image signal, and a driving control unit for controlling the first and second states of the image shift unit.

In the invention according to Claim 23, the display driving unit includes the resolution conversion unit and the driving control unit.

According to Claim 24, in the projection device according to Claim 23, the display driving unit further includes a format conversion unit for, if the image signal constituting the one screen is a signal of an interlace mode, converting the image signal into a signal of a progressive mode.

In the invention according to Claim 24, the display driving unit further includes the format conversion unit so that the image signal can operate in the same manner even if it is a signal of an interlace mode.

According to Claim 25, in the projection device according to Claim 22, the image shift means includes a polarization conversion unit that converts light into an S wave or a P wave, and a birefringence unit that causes birefringence in the S wave or the P wave.

In the invention according to Claim 25, the image shift means includes the polarization conversion unit and the birefringence unit, and performs a function of shifting the image.

According to Claim 26, in the projection device according to Claim 25, the polarization conversion unit and the birefringence unit are one or more in number, respectively.

In the invention according to Claim 26, the number of each of the polarization conversion unit and the birefringence unit, which constitute the image shift means, can be one or more.

According to Claim 27, in the projection device according to Claim 22, the image shift means includes a transmitting body, and a piezoelectric ceramic element connected to the transmitting body.

The invention according to Claim 27 relates to the projection device in which the image shift means is composed of the transmitting body and the piezoelectric ceramic element, unlike Claim 25, thereby performing the function of shifting the image.

According to Claim 28, in the projection device according to Claim 27, the transmitting body can be moved, and can transmit or shift the image by way of the movement.

In the invention according to Claim 28, it is possible to shift the image by controlling the movement of the transmitting body by means of the piezoelectric ceramic element.

According to Claim 29, in the projection device according to Claim 22, the image shift unit is disposed between the display panel and the optical path changing unit.

According to Claim 30, in the projection device according to Claim 22, the image shift unit is disposed between the optical path changing unit and the projection lens unit.

According to Claim 31, in the projection device according to Claim 22, the image shift unit is disposed between the projection lens unit and the screen.

The invention according to Claims 29 to 31 indicates a detailed position in which the image shift unit can be disposed within the projection device.

According to Claim 32, in the projection device according to Claim 22, the display panel is a single DMD panel, and the optical path changing unit includes a TIR prism.

According to Claim 33, in the projection device according to Claim 22, the display panel is a single DMD panel, and the optical path changing unit includes a dichroic mirror.

According to Claim 34, in the projection device according to Claim 22, the display panel is two or more DMD panels, and the optical path changing unit includes a X-prism.

According to Claim 35, in the projection device according to Claim 22, the display panel is two or more DMD panels, and the optical path changing unit includes a dichroic mirror.

According to Claim 36, in the projection device according to Claim 22, the display panel is a single LCD panel of a transmission type, and the optical path changing unit includes a TIR prism.

According to Claim 37, in the projection device according to Claim 22, the display panel a single LCD panel of a transmission type, and the optical path changing unit includes a dichroic mirror.

According to Claim 38, in the projection device according to Claim 22, the display panel is a single LCD panel of a transmission type, and the optical path changing unit includes a PBS.

According to Claim 39, in the projection device according to Claim 22, the display panel is two or more LCD panels of a transmission type, and the optical path changing unit includes a X-prism.

According to Claim 40, in the projection device according to Claim 22, the display panel is two or more LCD panels of a transmission type, and the optical path changing unit includes a dichroic mirror.

According to Claim 41, in the projection device according to Claim 22, the display panel is two or more LCD panels of a transmission type, and the optical path changing unit includes a PBS.

According to Claim 42 in the projection device according to Claim 22, the display panel is a single LCoS panel, and the optical path changing unit includes a TIR prism.

According to Claim 43, in the projection device according to Claim 22, the display panel is a single LCoS panel, and the optical path changing unit includes a dichroic mirror.

According to Claim 44, in the projection device according to Claim 22, the display panel is a single LCoS panel, and the optical path changing unit includes a PBS.

According to Claim 45, in the projection device according to Claim 22, the display panel is two or more LCoS panels, and the optical path changing unit includes a X-prism.

According to Claim 46, in the projection device according to Claim 22, the display panel is two or more LCoS panels, and the optical path changing unit is a dichroic mirror.

According to Claim 47, in the projection device according to Claim 22, the display panel is two or more LCoS panels, and the optical path changing unit is a PBS.

The invention according to Claims 32 to 47 is an implementation of actual materials, which can be applied to the display panel and the optical path changing unit. Real products can be implemented by using the materials.

A projection device according to Claim 48 of the present invention is a projection device including a display panel that supports the number of scanning lines, which is 1/n times greater than the number of scanning lines of an image signal constituting one screen, the projecting device including a display driving unit that converts the image signal constituting the one screen into n number of partial image signals so that the image signal is suitable for the display panel, an image forming unit including the display panel, wherein the image forming unit converts the n number of the partial image signals into n number of image optical signals, an optical path changing unit that forms n number of partial images by using the n number of the image optical signals, an image shift unit, which transmits a first partial image among the n number of the partial image intact in a first state, and shifts second to nth partial images among the n number of the partial image in a second state, under the control of the display driving unit, and a projection lens unit that projects the first to nth partial images outputted from the image shift unit onto the screen.

In the invention according to Claim 48, a person can view the screen with a resolution of an inputted image signal by using the display panel that supports only the number of a scanning line, which is 1/n times greater than that of scanning lines of an image signal constituting one screen.

According to Claim 49, in the projection device according to Claim 48, the display driving unit includes a resolution conversion unit for forming the partial image signals, and a driving control unit for controlling the first and second states of the image shift unit.

In the invention according to Claim 49, the resolution conversion unit of the display driving unit converts an inputted image signal of one screen into a partial image signal so as to be suitable for the display panel, and the driving control unit controls a state of the image shift unit.

According to Claim 50, in the projection device according to Claim 49, the display driving unit further includes a format conversion unit which, if the image signal constituting the one screen is a signal of an interlace mode, converts the image signal into a signal of a progressive mode.

In the invention according to Claim 50, an image signal constituting one screen, which is inputted to the display driving unit, can be applied to even a signal of an interlace mode.

According to Claim 51, in the projection device according to Claim 48, the resolution conversion unit forms the n number of the partial image signals by sampling an image signal corresponding to the order of the scanning lines having the same remnant when the order of the scanning lines of the image signal constituting the one screen is divided by n.

In the invention according to Claim 52, data of an image signal constituting one screen can be divided into n number of partial images by means of the resolution conversion unit.

According to Claim 52, in the projection device according to Claim 49, the resolution conversion unit forms the n number of the partial image signals in such a way as to n-divide a reference clock of the image signal constituting the one screen and then sample the image signal constituting the one screen at the rising edge and the falling edge of the n-divided clocks.

In the invention according to Claim 52, the resolution conversion unit forms n number of partial images in another method. Even in this method, n number of partial images can be formed.

According to Claim 53, in the projection device according to Claim 48, the image shift unit includes a polarization conversion unit that converts light into an S wave or a P wave, and a birefringence unit that causes birefringence in the S wave or the P wave.

In the invention according to Claim 53, the image shift means includes the polarization conversion unit and the birefringence unit, and performs a function of shifting an image.

According to Claim 54, in the projection device according to Claim 53, the polarization conversion unit and the birefringence unit are one or more in number, respectively.

The invention according to Claim 54 represents that the polarization conversion unit and the birefringence unit, which constitutes the image shift means, can be constructed one or more in number.

According to Claim 55, in the projection device according to Claim 48, the image shift unit includes a transmitting body, and a piezoelectric ceramic element connected to the transmitting body.

The invention according to Claim 55 relates to a projection device in which the image shift means includes the transmitting body and the piezoelectric ceramic element, unlike the invention according to Claim 53, thereby performing a function of shifting an image.

According to Claim 56, in the projection device according to Claim 55, the transmitting body can be moved, and can transmit or shift the image by way of the movement.

In the invention according to Claim 56, the piezoelectric ceramic element can control the movement of the transmitting body to shift the image.

A projection device according to Claim 57 of the present invention is a projection device including a display panel that supports the number of scanning lines, which is 1/n times greater than the number of scanning lines of an image signal constituting one screen, the projection device including a display driving unit that converts the image signal constituting the one screen into n number of partial image signals so that the image signal is suitable for the display panel, an image forming unit including the display panel, wherein the image forming unit converts the n number of the partial image signals into n number of image optical signals, an optical path changing unit that forms n number of partial images by using the n number of the image optical signals, an image shift unit, which transmits a first partial image among the n number of the partial image intact in a first state, and shifts second to nth partial images among the n number of the partial image in a second state, under the control of the display driving unit, and a projection lens unit that projects the first to nth partial images outputted from the image shift unit onto the screen, wherein the display panel is three transmission-type LCDs, the optical path changing unit includes a X-prism, and the image shift unit includes a polarization conversion unit that converts light into an S wave or a P wave, and a birefringence unit that causes birefringence in the S wave or the P wave.

The invention according to Claim 57 discloses an embodiment in which the display panel that supports only the number of scanning lines which is 1/n times greater than the number of scanning lines of an image signal constituting one screen is three LCDs of a transmission type, the optical path changing unit includes the X-prism, and the image shift unit has the polarization conversion unit. Thereby, a partial image is formed to be suitable for a display panel of a low resolution and is properly projected onto a screen. This makes a person view the screen with a resolution of an image signal constituting one screen.

A projection device according to Claim 58 of the present invention is a projection device including a display panel that supports the number of scanning lines, which is 1/n times greater than the number of scanning lines of an image signal constituting one screen, the projection device including a display driving unit that converts the image signal constituting the one screen into n number of partial image signals so that the image signal is suitable for the display panel, an image forming unit including the display panel, wherein the image forming unit converts the n number of the partial image signals into n number of image optical signals, an optical path changing unit that forms n number of partial images by using the n number of the image optical signals, an image shift unit, which transmits a first partial image among the n number of the partial image intact in a first state, and shifts second to nth partial images among the n number of the partial image in a second state, under the control of the display driving unit, and a projection lens unit that projects the first to nth partial images outputted from the image shift unit onto the screen, wherein the display panel is a single DMD panel, the optical path changing unit includes a TIR prism, and the image shift unit includes a transmitting body, and a piezoelectric ceramic element connected to the transmitting body.

The invention according to Claim 58 discloses an embodiment in which the display panel that supports only the number of scanning lines which is 1/n times greater than the number of scanning lines of an image signal constituting one screen is the single DMD panel, the optical path changing unit includes the TIR prism, and the image shift unit includes the transmitting body and the piezoelectric ceramic element. Thereby, a partial image is formed to be suitable for a display panel of a low resolution and is properly projected onto a screen. This makes a person view the screen with a resolution of an image signal constituting one screen.

Hereinafter, the present invention will now be described in detail in connection with preferred embodiments with reference to the accompanying drawings.

FIG. 1 is a block diagram of a projection device, which can increase a resolution according to the present invention.

Referring to FIG. 1, the high resolution projection device of the present invention includes an image forming unit 100, an optical path changing unit 110, an image shift unit 120, a projection lens unit 130 and a display driving unit 140.

<Image Forming Unit>

The image forming unit 100 includes a digital display panel that supports the number of pixels smaller than a resolution of a frame to be displayed. Preferably, the digital display panel according to the present invention supports pixels of 1/n times (n is a natural number) of the whole resolution for forming a frame.

Hereinafter, one frame to be displayed is called the whole image. An image formed by the digital display panel is called an image optical signal.

For example, if the whole image, which is projected by the projection device according to the present invention and is thus viewed to the eyes of a person has a resolution of 1080p, a resolution that is supported by the digital display panel is 540p. Examples of this digital display panel may include a LCD panel, a DMD panel and an LCoS panel and so on.

<Optical Path Changing Unit>

The optical path changing unit 110 reflects each of n number of image optical signals, which are outputted from the image forming unit 100, to form n number of partial images depending on the image optical signals. This optical path changing unit 110 can be selected depending on the type of a panel included in the image forming unit 100, or can be omitted.

For example, in the case where a single DMD panel is used as the digital display panel of the image forming unit 100, the optical path changing unit 110 includes a Total Internal Reflection (TIR) prism. If a single LCoS panel is used as the digital display panel, the optical path changing unit 110 includes a Polarizing Beam Splitter (PBS). If three LCoS panels are used as the digital display panel, the optical path changing unit 110 includes a PBS or a X-prism. If three transmission-type LCDs are used as the digital display panel, the optical path changing unit 110 includes a X-prism. Finally, if a transmission-type a single LCD panel is used as the digital display panel, the optical path changing unit 110 is not required.

<Image Shift Unit>

The image shift unit 120, in a first state, transmits a first partial image, which is outputted from the optical path changing unit 110 intact, and, in a second state, consecutively shifts and transmits second to nth partial images, which are outputted from the optical path changing unit 110, on a 1/n pixel basis.

As the first partial image and the second to nth partial images are sequentially transmitted, the whole image of a resolution higher than that of the partial image itself is displayed.

In this time, if n is 2, the first state is a turn-off state, and the second state is in a turn-on state. If n is 3 or more, the first state is in a turn-off state, and the second state is in a state where the remaining second to nth partial image are sequentially shifted.

For example, if a resolution of the whole image to be displayed is 1080p, the image forming unit 100 and the optical path changing unit 110 output a first partial image having a resolution of 540p. In this time, if the image shift unit 120 is turned off, the first partial image passes through the image shift unit 120 and is then projected through the projection lens unit 130 without any change.

Then, the image forming unit 100 and the optical path changing unit 110 output a second partial image having a resolution of 540p. If the image shift unit 120 is turned on, the second partial image is shifted by ½ pixel by means of the image shift unit 120 and is then projected through the projection lens unit 130.

If this process is performed, while the first partial image which is projected with the image shift unit 120 being turned off and the second partial image which is projected with the screen shift unit being turned on are consecutively displayed on the screen, the whole image is formed by way of an afterimage effect. For example, while a first partial image of 540p and a second partial image of 540p are displayed, the whole image of 1080p is formed by way of an afterimage effect.

Preferably, the first partial image of 540p, which is projected with the image shift unit 120 being turned off, corresponds to an odd-numbered line of a frame of 1080p. The second partial image of 540p, which is projected with the image shift unit 120 being turned on, corresponds to an even-numbered line of a frame of 1080p, which is shifted by the image shift unit 120.

<Display Driving Unit>

The display driving unit 140 converts an externally input image signal into an image signal of a-predetermined format, and converts the converted image signal into n number of partial image signal the resolution of which is 1/n-times higher than that of the converted image signal, so that the image forming unit 100 forms n number of image optical signals corresponding to the n number of the partial image signals. Driving of the first state and the second state of the image shift unit 120 is thus controlled according to the n number of the image optical signals.

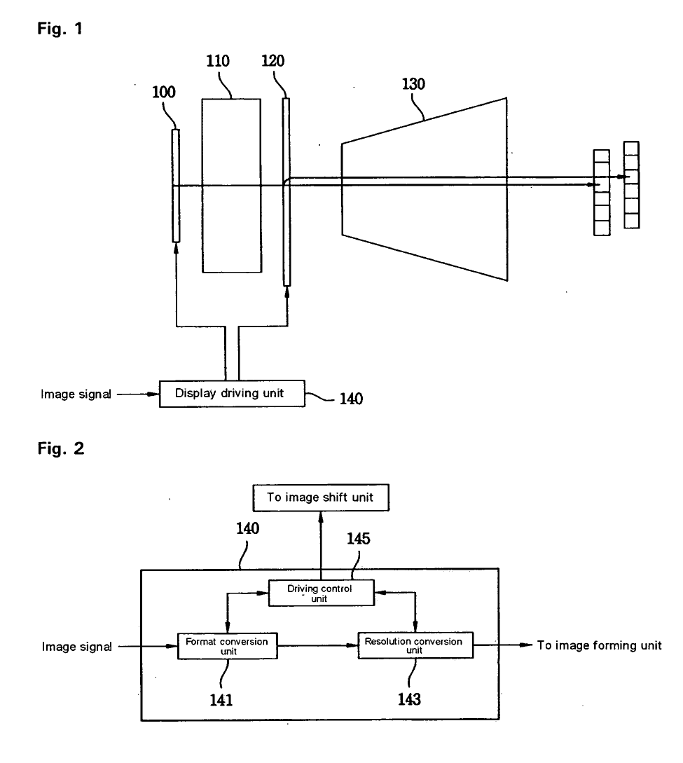

FIG. 2 is a block diagram of the display driving unit 140 included in the projection device according to the present invention. Referring to FIG. 2, the display driving unit 140 includes a format conversion unit 141, a resolution conversion unit 143 and a driving control unit 145.

The format conversion unit 141 converts an inputted image signal that supports a resolution of an interlace mode into an image signal that supports a resolution of a progressive mode.

The resolution conversion unit 143 samples image signals corresponding to lines of order having the same remnant when order of each line constituting the resolution of the progressive mode is divided by n, and combines the sampled image signals to form n number of partial image signals.

For example, if n=2, the resolution conversion unit 143 samples image signals corresponding to odd-numbered lines that constitute the resolution of the progressive mode and then combines the image signal into one, and samples image signals corresponding to an even-numbered line and then combines the image signals into one.

Furthermore, in the case where n=3, if order of respective lines that constitute the resolution of the progressive mode is divided by 3, the remnant is 0, 1 or 2. Thus, image signals corresponding to the first, fourth, seventh, fifth, eighth, . . . lines are combined into one, and image signals corresponding to the third, sixth, ninth, . . . lines into are combined one.

The driving control unit 145 controls the operation of each of the format conversion unit 141 and the resolution conversion unit 143, and controls the operation of the first state and the second state of the image shift unit 120.

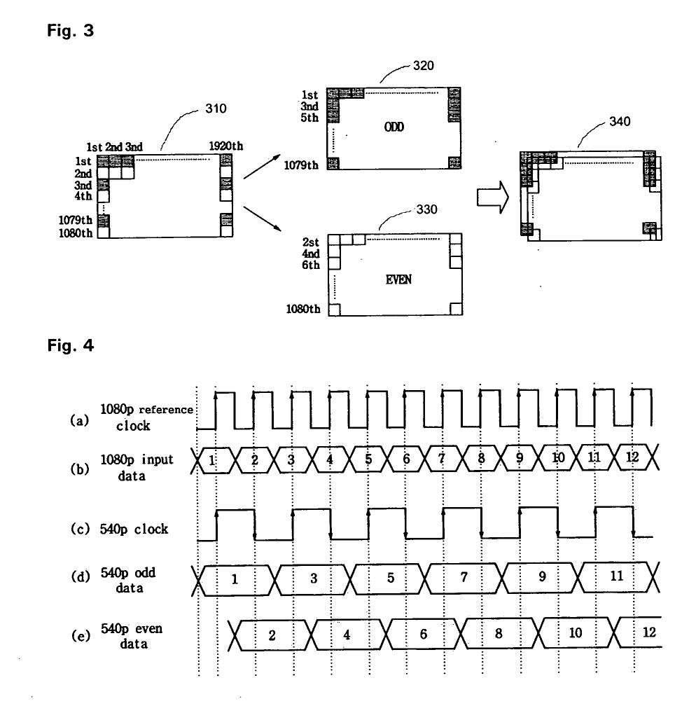

FIG. 3 is a view for explaining the operation of the display driving unit 140 according to the present invention. In this time, n=2.

Referring to FIG. 3, reference numeral 310 shows a state where an image signal of a resolution 1080i of the interlace mode is converted into an image signal of a resolution 1080p of the progressive mode by means of the format conversion unit 141 shown in FIG. 2.

Reference numeral 320 shows a state where the image signal of 1080p is converted into an image signal of 540p that corresponds to an odd-numbered line of the image signal of 1080p by means of the resolution conversion unit 143 shown in FIG. 2.

Reference numeral 330 shows a state where the image signal of 1080p is converted into the image signal of 540p corresponding to an even-numbered line of the image signal of 1080p by means of the resolution conversion unit 143 shown in FIG. 2.

Reference numeral 340 shows an image of 1080p, which is displayed when the partial image of 540p corresponding to the odd-numbered line and the partial image of 540p corresponding to the even-numbered line, which are generated by the resolution conversion unit 143 of FIG. 2, are overlapped.

That is, the driving control unit 145 of the display driving unit 140 turns off the image shift unit 120 simultaneously when the image signal of 540p, which corresponds to the odd-numbered line, is applied to the image forming unit 100.

Then, a partial image corresponding to the image signal of 540p, which corresponds to the odd-numbered line, is projected onto the screen through the projection lens unit 130.

The driving control unit 145 of the display driving unit 140 then turns on the image shift unit 120 while applying the image signal of 540p, which corresponds to the even-numbered line, to the image forming unit 100.

Thus, while the partial image corresponding to the image signal of 540p, which corresponds to the even-numbered line, is shifted by ½ pixel, it is projected onto the screen through the projection lens unit 130, so that a complete image of 1080p is formed by way of the afterimage effect. Accordingly, assuming that an image of 60 frames is projected onto the screen per second, the projection device according to the present invention can project 120 partial images per second.

Through this process, an image having the resolution of 1080p is formed through the image forming unit 100 that supports the resolution of 540p.

FIG. 4 shows an operating waveform of the display driving unit 140 according to the present invention;

FIGS. 4(a) and 4(b) show a reference clock waveform and a data waveform corresponding to the resolution of 1080p, which are transmitted from the format conversion unit 141 to the resolution conversion unit 143 in FIG. 2.

FIG. 4(c) shows a clock waveform corresponding to a resolution of 540p, which is 2-divided by the resolution conversion unit 143. FIGS. 4(d) and 4(e) are a data waveform corresponding to an odd-numbered line, and a data waveform corresponding to an even-numbered line, respectively.

In this time, as shown in FIG. 4(c), the resolution conversion unit 143 form a clock waveform corresponding to 540p by 2-dividing the clock waveform corresponding to 1080p to.

Thereafter, the resolution conversion unit 143 samples the data waveform corresponding to the resolution of 1080p at the rising edge of the clock waveform corresponding to 540p, thus forming the data waveform corresponding to the odd-numbered line as shown in FIG. 4(d). Also, the resolution conversion unit 143 samples the data waveform corresponding to the resolution of 1080p at the falling edge of the clock waveform corresponding to 540p, thus forming the data waveform corresponding to the even-numbered line as shown in FIG. 4(e).

The above-described waveforms are waveforms where n=2. Generally, a clock waveform is n-divided to form a clock waveform corresponding to a resolution of 1/n times of a resolution of the whole image.

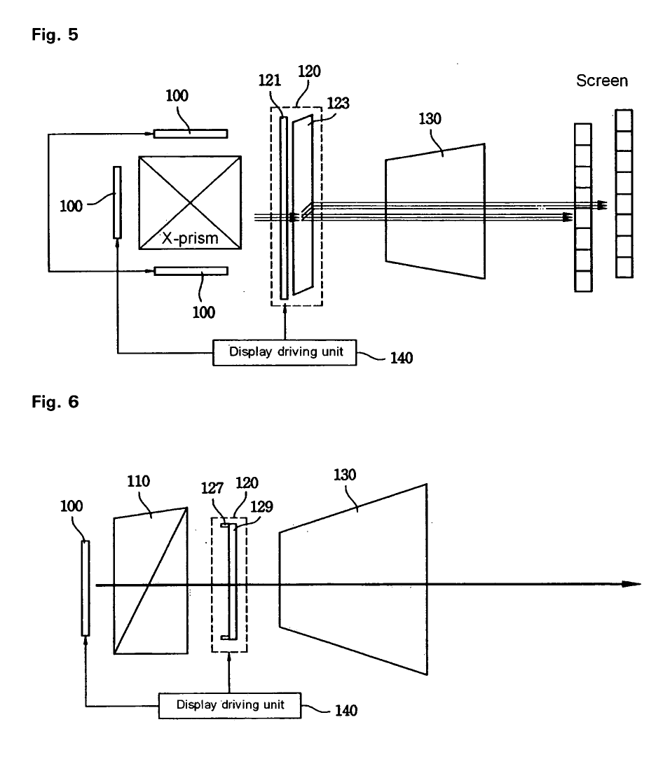

FIG. 5 is a block diagram of a projection device in which a resolution can be increased according to a first embodiment of the present invention.

Referring to FIG. 5, in the first embodiment of the projection device according to the present invention, an image forming unit 100 includes three LCDs, an optical path changing unit 110 includes a X-prism, and an image shift unit 120 includes a polarization conversion unit 121 and a birefringence unit 123. In this time, the birefringence unit 123 according to a first embodiment of the present invention is calcite.

That is, light that has passed through the respective transmission-type LCD panels, which corresponds to R, G and B, are converted into an S wave or a P wave by means of the polarization deflection device 121. The light that is converted into the S wave by the polarization deflection device 121 is shifted by the birefringence unit 123. The light that is converted into the P wave by the polarization deflection device 121 passes through the birefringence unit 123 intact.

Accordingly, if the display driving unit 140 controls the LCD panels according to the data waveform of 540p, which corresponds to the odd-numbered line formed by the resolution conversion unit 143 of the display driving unit 140, the light that has passed through the LCD panels forms one partial image, while being reflected from the X-prism.

In this time, if the display driving unit 140 operates the polarization conversion unit 121 to convert the partial image into the P wave, the birefringence unit 123 transmits the partial image converted into the P wave.

Thereafter, if the display driving unit 140 controls the LCD panel according to the data waveform of 540p corresponding to the even-numbered line formed by the resolution conversion unit 143 of the display driving unit 140, the light that has passed through the LCD panel forms another one partial image. In this time, the driving control unit 145 of the display driving unit 140 operates the polarization conversion unit 121 to convert the partial image into the S wave, the birefringence unit 123 shifts the one partial image.

In this time, since the amount of the shift is a semi-pixel, an image of 1080p is formed as two partial images are overlapped.

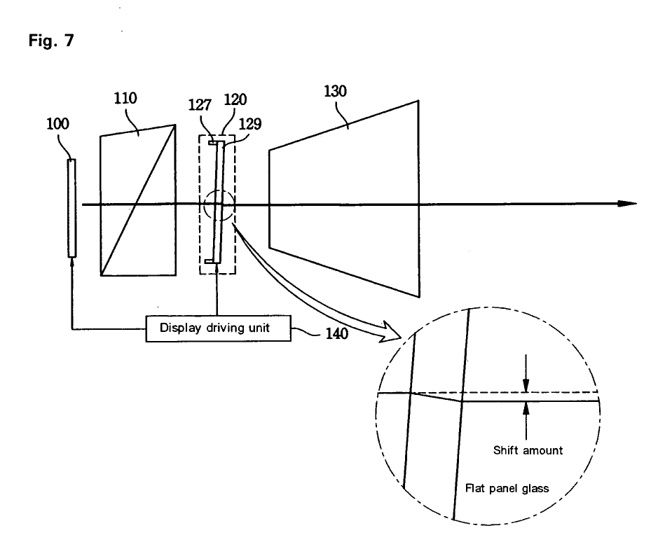

FIGS. 6 and 7 are block diagrams of a projection device in which a resolution can be increased according to a second embodiment of the present invention.

Referring to FIGS. 6 and 7, in the second embodiment of the projection device according to the present invention, an image forming unit 100 includes a DMD panel, an optical path changing unit 110 includes a TIR prism, and an image shift unit 120 includes a flat panel glass 129 having a piezoelectric ceramic element 127 attached to both ends.

As shown in FIG. 6, in the case where the display driving unit 140 forms a partial image of 540p corresponding to an odd-numbered line through a DMD panel while not applying a signal to the piezoelectric ceramic element 127 attached to both ends of the flat panel glass 129, the flat panel glass becomes parallel to the DMD panel, so that a position onto which the image of 540p is projected returns to its original position.

Furthermore, as shown in FIG. 7, in the case where the display driving unit 140 forms the partial image of 540p, which corresponds to the even-numbered line, through the DMD panel while applying a signal to the piezoelectric ceramic element 127, pressure is generated in the piezoelectric ceramic element 127. Thus, as an equilibrium state of the flat panel glass and the DMD panel is upset, the partial image shifts. Therefore, the partial image corresponding to the odd-numbered line and the partial image corresponding to the even-numbered line are overlapped to form the image of 1080p.

In the aforementioned second embodiment, if n=2 or n =3, the display driving unit controls the amount of a voltage applied to the piezoelectric ceramic element 127 to be different, so that n number of the partial images is sequentially shifted by the 1/n pixel.

According to a projection device in accordance with the present invention, an image of a high resolution can be provided by using a digital display panel that supports a low resolution.

As described above, the present invention can provide a projection device including a display panel having a resolution lower than that of an image signal constituting one screen.

The invention being thus described, it will be obvious that the same may be varied in many ways. Such variations are not to be regarded as a departure from the spirit and scope of the invention, and all such modifications as would be obvious to one skilled in the art are intended to be included within the scope of the following Claims.

1. A projection device that projects an image signal onto a screen, comprising:
image forming means that forms an image by using an inputted image signal; and
image shift means that transmits the image intact or shifts the image, and projects the intact or shifted image onto the screen.

2. The projection device according to claim 1, wherein the image shift means comprises a polarization conversion unit that converts light into an S wave or a P wave, and a birefringence unit that causes birefringence in the S wave or the P wave.

3. The projection device according to claim 2, wherein the polarization conversion unit and the birefringence unit are one or more in number, respectively.

4. The projection device according to claim 1, wherein the image shift means comprises a transmitting body, and a piezoelectric ceramic element connected to the transmitting body.

5. The projection device according to claim 4, wherein the transmitting body can be moved, and can transmit or shift the image by way of the movement.

6. A projection method in which an image signal is projected onto a screen, comprising the steps of:
an image forming step of forming an image by using an inputted image signal; and
an image shift step of transmitting the image intact or shifting the image, thus projecting the image onto the screen.

7. The projection method according to claim 6, wherein the image shift step is performed by an image shift means including a polarization conversion unit that converts light into an S wave or a P wave, and a birefringence unit that causes birefringence in the S wave or the P wave.

8. The projection method according to claim 7, wherein the polarization conversion unit and the birefringence unit are one or more in number, respectively.

9. The projection method according to claim 6, wherein the image shift step is performed by image shift means including a transmitting body, and a piezoelectric ceramic element connected to the transmitting body.

10. The projection method according to claim 9, wherein the transmitting body can be moved, and can transmit or shift the image by way of the movement.

11. A projection device that projects an image signal onto a screen, comprising:
partial image forming means that divides an image signal constituting one screen so that the image signal is suitable for a resolution of a display panel, thus forming several partial images; and
image shift means, which transmits or shifts the several partial images and thus projects the image onto the screen.

12. The projection device according to claim 11, wherein the image shift means comprises a polarization conversion unit that converts light into an S wave or a P wave, and a birefringence unit that causes birefringence in the S wave or the P wave.

13. The projection device according to claim 12, wherein the polarization conversion unit and the birefringence unit are one or more in number, respectively.

14. The projection device according to claim 11, wherein the image shift means comprises a transmitting body, and a piezoelectric ceramic element connected to the transmitting body.

15. The projection device according to claim 14, wherein the transmitting body can be moved, and can transmit or shift the image by way of the movement.

16. The projection device according to claim 11, wherein the image shift means can be disposed at a given position between the display panel and the screen.

17. A projection method that projects an image signal onto a screen, comprising:
a partial image forming step of dividing an image signal constituting one screen so that the image signal is suitable for a resolution of a display panel, thus forming several partial images; and
an image shift step of transmitting or shifting the several partial images, thus projecting the image onto the screen.

18. The projection method according to claim 17, wherein the image shift step is performed by an image shift means including a polarization conversion unit that converts light into an S wave or a P wave, and a birefringence unit that causes birefringence in the S wave or the P wave.

19. The projection method according to claim 18, wherein the polarization conversion unit and the birefringence unit are one or more in number, respectively.

20. The projection method according to claim 17, wherein the image shift step is performed by image shift means including a transmitting body, and a piezoelectric ceramic element connected to the transmitting body.

21. The projection method according to claim 20, wherein the transmitting body can be moved, and can transmit or shift the image by way of the movement.

22. A projection device that projects an image signal onto a screen, comprising:
a display driving unit that transforms an inputted image signal, which constitutes one screen, into a partial image signal so that the image signal is suitable for a resolution of a display panel;
an image forming unit including the display panel, the image forming unit converting the partial image signal into an image optical signal;
an optical path changing unit that forms a partial image by using the image optical signal;
an image shift unit, which transmits the partial image intact in a first state and shifts the partial image in a second state, under the control of the display driving unit; and
a projection lens unit that projects the partial image outputted from the image shift unit onto the screen.

23. The projection device according to claim 22, wherein the display driving unit comprises a resolution conversion unit for forming the partial image signal, and a driving control unit for controlling the first and second states of the image shift unit.

24. The projection device according to claim 23, wherein the display driving unit further comprises a format conversion unit which, if the image signal constituting the one screen is a signal of an interlace mode, converts the image signal into a signal of a progressive mode.

25. The projection device according to claim 23, wherein the image shift unit comprises a polarization conversion unit that converts light into an S wave or a P wave, and a birefringence unit that causes birefringence in the S wave or the P wave.

26. The projection device according to claim 25, wherein the polarization conversion unit and the birefringence unit are one or more in number, respectively.

27. The projection device according to claim 22, wherein the image shift unit comprises a transmitting body, and a piezoelectric ceramic element connected to the transmitting body.

28. The projection device according to claim 27, wherein the transmitting body can be moved, and can transmit or shift the image by way of the movement.

29. The projection device according to claim 22, wherein the image shift unit is disposed between the display panel and the optical path changing unit.

30. The projection device according to claim 22, wherein the image shift unit is disposed between the optical path changing unit and the projection lens unit.

31. The projection device according to claim 22, wherein the image shift unit is disposed between the projection lens unit and the screen.

32. The projection device according to claim 22, wherein the display panel is a single DMD panel, and the optical path changing unit includes a TIR prism.

33. The projection device according to claim 22, wherein the display panel is a single DMD panel, and the optical path changing unit includes a dichroic mirror.

34. The projection device according to claim 22, wherein the display panel is two or more DMD panels, and the optical path changing unit includes a X-prism.

35. The projection device according to claim 22, wherein the display panel is two or more DMD panels, and the optical path changing unit includes a dichroic mirror.

36. The projection device according to claim 22, wherein the display panel is a single LCD panel of a transmission type, and the optical path changing unit includes a TIR prism.

37. The projection device according to claim 22, wherein the display panel a single LCD panel of a transmission type, and the optical path changing unit includes a dichroic mirror.

38. The projection device according to claim 22, wherein the display panel is a single LCD panel of a transmission type, and the optical path changing unit includes a PBS.

39. The projection device according to claim 22, wherein the display panel is two or more LCD panels of a transmission type, and the optical path changing unit includes a X-prism.

40. The projection device according to claim 22, wherein the display panel is two or more LCD panels of a transmission type, and the optical path changing unit includes a dichroic mirror.

41. The projection device according to claim 22, wherein the display panel is two or more LCD panels of a transmission type, and the optical path changing unit includes a PBS.

42. The projection device according to claim 22, wherein the display panel is a single LCoS panel, and the optical path changing unit includes a TIR prism.

43. The projection device according to claim 22, wherein the display panel is a single LCoS panel, and the optical path changing unit includes a dichroic mirror.

44. The projection device according to claim 22, wherein the display panel is a single LCoS panel, and the optical path changing unit includes a PBS.

45. The projection device according to claim 22, wherein the display panel is two or more LCoS panels, and the optical path changing unit includes a X-prism.

46. The projection device according to claim 22, wherein the display panel is two or more LCoS panels, and the optical path changing unit is a dichroic mirror.

47. The projection device according to claim 22, wherein the display panel is two or more LCoS panels, and the optical path changing unit is a PBS.

48. A projection device including a display panel that supports the number of scanning lines, which is 1/n times greater than the number of scanning lines of an image signal constituting one screen, comprising:
a display driving unit that converts the image signal constituting the one screen into n number of partial image signals so that the image signal is suitable for the display panel;
an image forming unit including the display panel, wherein the image forming unit converts the n number of the partial image signals into n number of image optical signals;
an optical path changing unit that forms n number of partial images by using the n number of the image optical signals;
an image shift unit, which transmits a first partial image among the n number of the partial image intact in a first state, and shifts second to nth partial images among the n number of the partial image in a second state, under the control of the display driving unit; and
a projection lens unit that projects the first to nth partial images outputted from the image shift unit onto the screen.

49. The projection device according to claim 48, wherein the display driving unit comprises a resolution conversion unit for forming the partial image signals, and a driving control unit for controlling the first and second states of the image shift unit.

50. The projection device according to claim 49, wherein the display driving unit further comprises a format conversion unit which, if the image signal constituting the one screen is a signal of an interlace mode, converts the image signal into a signal of a progressive mode.

51. The projection device according to claim 48, wherein the resolution conversion unit forms the n number of the partial image signals by sampling an image signal corresponding to the order of the scanning lines having the same remnant when the order of the scanning lines of the image signal constituting the one screen is divided by n.

52. The projection device according to claim 48, wherein the resolution conversion unit forms the n number of the partial image signals in such a way as to n-divide a reference clock of the image signal constituting the one screen and then sample the image signal constituting the one screen at the rising edge and the falling edge of the n-divided clocks.

53. The projection device according to claim 48, wherein the image shift unit comprises a polarization conversion unit that converts light into an S wave or a P wave, and a birefringence unit that causes birefringence in the S wave or the P wave.

54. The projection device according to claim 53, wherein the polarization conversion unit and the birefringence unit are one or more in number, respectively.

55. The projection device according to claim 48, wherein the image shift unit comprises a transmitting body, and a piezoelectric ceramic element connected to the transmitting body.

56. The projection device according to claim 55, wherein the transmitting body can be moved, and can transmit or shift the image by way of the movement.

57. A projection device including a display panel that supports the number of scanning lines, which is 1/n times greater than the number of scanning lines of an image signal constituting one screen, comprising:
a display driving unit that converts the image signal constituting the one screen into n number of partial image signals so that the image signal is suitable for the display panel;
an image forming unit including the display panel, wherein the image forming unit converts the n number of the partial image signals into n number of image optical signals;
an optical path changing unit that forms n number of partial images by using the n number of the image optical signals;
an image shift unit, which transmits a first partial image among the n number of the partial image intact in a first state, and shifts second to nth partial images among the n number of the partial image in a second state, under the control of the display driving unit; and
a projection lens unit that projects the first to nth partial images outputted from the image shift unit onto the screen,
wherein the display panel is three transmission-type LCDs,
the optical path changing unit includes a X-prism, and
the image shift unit comprises a polarization conversion unit that converts light into an S wave or a P wave, and a birefringence unit that causes birefringence in the S wave or the P wave.

58. A projection device including a display panel that supports the number of scanning lines, which is 1/n times greater than the number of scanning lines of an image signal constituting one screen, comprising:
a display driving unit that converts the image signal constituting the one screen into n number of partial image signals so that the image signal is suitable for the display panel;
an image forming unit including the display panel, wherein the image forming unit converts the n number of the partial image signals into n number of image optical signals;
an optical path changing unit that forms n number of partial images by using the n number of the image optical signals;
an image shift unit, which transmits a first partial image among the n number of the partial image intact in a first state, and shifts second to nth partial images among the n number of the partial image in a second state, under the control of the display driving unit; and
a projection lens unit that projects the first to nth partial images outputted from the image shift unit onto the screen,
wherein the display panel is a single DMD panel,
the optical path changing unit includes a TIR prism, and the image shift unit comprises a transmitting body, and a piezoelectric ceramic element connected to the transmitting body.
